(19) United States
(12) Patent Application Publication
(10) Pub. No.: US 2021/0239994 A1
(43) Pub. Date: Aug. 5, 2021

(54) HEAD MOUNTED DEVICE

(71) Applicant: CANON KABUSHIKI KAISHA, Tokyo (JP)

(72) Inventor: Takashi Torii, Kanagawa (JP)

(21) Appl. No.: 17/157,300

(22) Filed: Jan. 25, 2021

(30) Foreign Application Priority Data
Jan. 31, 2020 (JP) 2020-015877

(51) Int. Cl. G02B 27/01

(52) U.S. Cl. CPC G02B 27/0176; G02B 2027/0187; G02B 2027/014; G02B 27/0172

(57) ABSTRACT

A head mounted device to be mounted on a head of a user includes a display unit configured to display an image, a movable portion configured to be movable with the display unit in a vertical direction to eyes of the user when the head mounted device is mounted on the head of the user, an operation portion configured to be operable by the user, and a rotor configured to rotate by operation of the operation portion and to move the movable portion by the rotation.

### BACKGROUND

### Field of the Disclosure

The present disclosure relates to a head mounted device to be mounted on a head of a user.

### Description of the Related Art

In recent years, a head mounted display (HMD) has been used as one of devices to enable a user to experience virtual reality (VR) and augmented reality (AR). The HMD commonly includes a mount portion for the user to mount the HMD on a head and a display unit for the user to observe an image. Further, an HMD has been known that includes a mechanism to adjust relative position and orientation of the mount portion and the display unit in order to handle a large variety of head shapes of users. In particular, a degree of adjustment freedom in a vertical direction improves usability because the user can adjust the display unit to a position where the user can clearly observe the image while the mount portion is in contact with a position where the user feels comfortable.

Japanese Patent Application Laid-Open No. 2007-64997 discusses a technology to vertically adjust the display unit by using an adjustment mechanism of an arm having a degree of rotation freedom. In the technology, operation force to adjust a position of the display unit is transmitted to the mount portion. Therefore, when a hand is released after the adjustment, the display unit may be shifted from the adjusted position.

The present disclosure is directed to a head mounted device that suppresses occurrence of shift of a mount portion caused by operation force to move a display unit.

### SUMMARY

According to an aspect of the present disclosure, a head mounted device to be mounted on a head of a user includes a display unit configured to display an image, a movable portion configured to be movable with the display unit in a vertical direction to eyes of the user when the head mounted device is mounted on the head of the user, an operation portion configured to be operable by the user, and a rotor configured to rotate by operation of the operation portion and to move the movable portion by the rotation.

Further features of the present disclosure will become apparent from the following description of exemplary embodiments with reference to the attached drawings.

### BRIEF DESCRIPTION OF THE DRAWINGS

FIG. 1 is a birds eye view according to a first exemplary embodiment

FIG. 2 is an internal cross-sectional view according to one or more aspects of the present disclosure.

FIG. 3 is a schematic diagram illustrating force acting on a fixing portion according to one or more aspects of the present disclosure.

FIGS. 4A and 4B each illustrate a state where a display unit is vertically adjusted according to one or more aspects of the present disclosure.

FIG. 5 is a bird's eye view according to one or more aspects of the present disclosure.

FIGS. 6A and 6B each illustrate a state where a display unit is vertically adjusted according to one or more aspects of the present disclosure.

FIG. 7 is a bird's eye view according to one or more aspects of the present disclosure.

FIG. 8 is an internal cross-sectional view according to one or more aspects of the present disclosure.

FIG. 9 is a bird's eye view in another mode according to one or more aspects of the present disclosure.

FIG. 10 is an internal cross-sectional view in the other mode according to one or more aspects of the present disclosure.

FIGS. 11A and 11B each illustrate a state where a display unit in the other mode is vertically adjusted according to one or more aspects of the present disclosure.

FIG. 12 is a bird's eye view according to one or more aspects of the present disclosure.

FIG. 13 is an internal cross-sectional view according to one or more aspects of the present disclosure.

FIG. 14 is a diagram illustrating a direction of head pressing force of a fixing portion and a direction of operation force for front/rear tilt according to one or more aspects of the present disclosure.

FIGS. 15A and 15B illustrate states before and after a display unit according to one or more aspects of the present disclosure is tilted.

### DESCRIPTION OF THE EMBODIMENTS

A head mounted display (HMD) is described as an example of a head mounted image display device according to any of exemplary embodiments of the present disclosure.

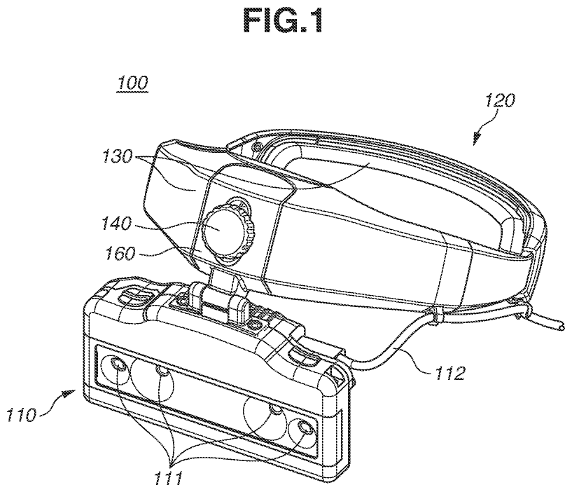

FIG. 1 is a bird's eye view of an HMD 100 according to a first exemplary embodiment. The HMD 100 includes a display unit 110, a mount portion 120, and a movable portion 160.

The display unit 110 uses a display device (not illustrated) and a display optical system (not illustrated) to guide an enlarged virtual image of the display device to eyes of a user (not illustrated). As a result, the user can observe an image different from a real world, displayed in front of the eyes, and experience virtual reality (VR). As the display device, an electroluminescence (EL) panel, a liquid crystal display (LCD), etc. are applicable; however, the display device is not limited thereto.

Further, the display unit 110 may include a plurality of cameras 111 capturing images in front of the eyes of the user. An image in which computer graphics (CC), etc. are superimposed on real images acquired by the cameras 111 is generated and is displayed, which causes the user to observe the image extended from the real world by the CC, etc. This enables the user to experience augmented reality (AR). Superimposition of the CC, etc. on the captured real images may be realized by the display unit 110, or by different hardware connected through a cable 112.

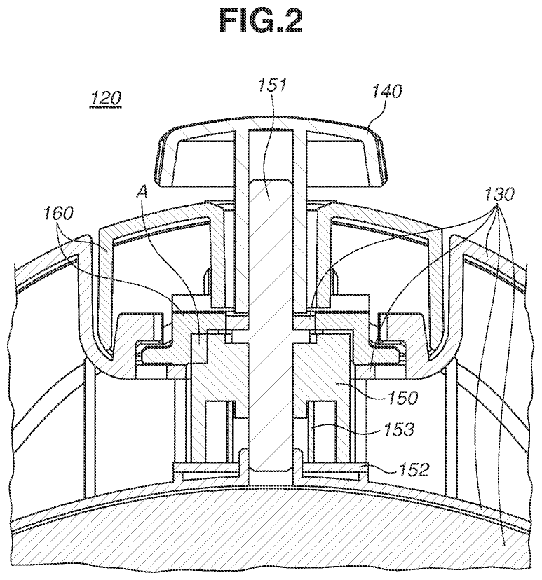

The mount portion 120 includes a fixing portion 130, an operation portion 140, and a rotor (not illustrated). The rotor is described below with reference to FIG. 2. The fixing portion 130 is not limited to a specific configuration and may include a plurality of components as long as the fixing portion 130 can fix the HMD 100 to a head of the user. The operation portion 140 has a dial shape, and the dial is rotated.

The movable portion 160 is connected to the display unit 110. In addition, the movable portion 160 is connected to the mount portion 120 so as to be linearly movable, and may include a plurality of components.

FIG. 2 is an internal cross-sectional view of the mount portion 120 according to the first exemplary embodiment. The mount portion 120 includes a rotor 150, a shaft 151, a friction plate 152, and a spring 153.

The rotor 150 rotates with linear movement of the movable portion 160. The rotor 150 and the movable portion 160 may include, for example, a rack and a pinion, and are not limited to a specific configuration. The rotor 150 and the movable portion 160 engage with each other at an A portion. The operation portion 140 and the rotor 150 are coupled by the shaft 151. Accordingly, when the operation portion 140 rotates, the rotor 150 rotates. Since the rotor 150 and the movable portion 160 engage with each other at the A portion, rotary motion of the operation portion 140 is converted into linear motion of the movable portion 160.

The mount portion 120 includes a holding member to prevent the linear movement of the movable portion 160 by a weight of the display unit 110. The spring 153 makes elastic force to act between the friction plate 152 and the rotor 150. The elastic force of the spring 153 generates frictional force in the fixing portion 130, which makes it possible to prevent the linear movement of the movable portion 160. The holding member may have a configuration using a torque hinge as long as the holding member is a mechanism using friction. More specifically, one end of the torque hinge may be connected to the fixing portion 130, and the other end may be connected to the rotor 150 or the shaft 151. Further, friction may be generated between the fixing portion 130 and the movable portion 160. More specifically, the movable portion 160 may be urged against the fixing portion 130 by a plate spring. Alternatively, the fixing portion 130 and the movable portion 160 may be press-fitted.

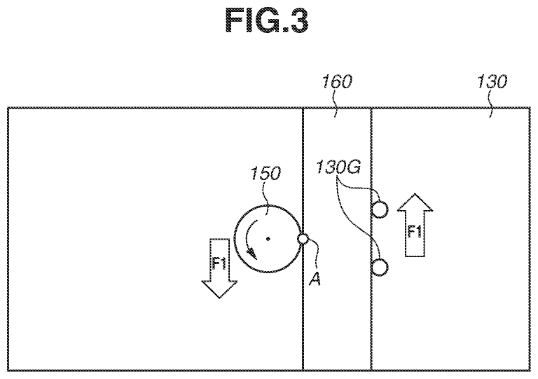

FIG. 3 is a schematic diagram illustrating anti-shifting property of the fixing portion 130 according to the first exemplary embodiment. The fixing portion 130 includes guides 130G, and the movable portion 160 is linearly movable in a vertical direction.

When the rotor 150 rotates and the movable portion 160 moves upward, the movable portion 160 receives force from the rotor 150. The movable portion 160 receiving the force generates sliding resistance F1 by moving while being pressed against the guides 1301. On the other hand, the rotor 150 receives reaction force of the operation force, and generates the sliding resistance F1 by rotating while being pressed against the fixing portion 130. Therefore, although the force acts on the fixing portion 130 is balanced in the vertical direction, torque rotating the fixing portion 130 in a counterclockwise direction is generated. The torque is small component force as sliding resistance. Therefore, the torque suppresses occurrence of shift of the fixing portion 130 caused by the operation of the operation portion 140 (not illustrated) coupled to the rotor 150. Further, the shift of the fixing portion 130 caused by the operation of the operation portion 140 (not illustrated) coupled to the rotor 150 may be suppressed by extending a part of the fixing portion 130 coming into contact with the head of the user to outside of the position where the sliding resistance F1 is generated.

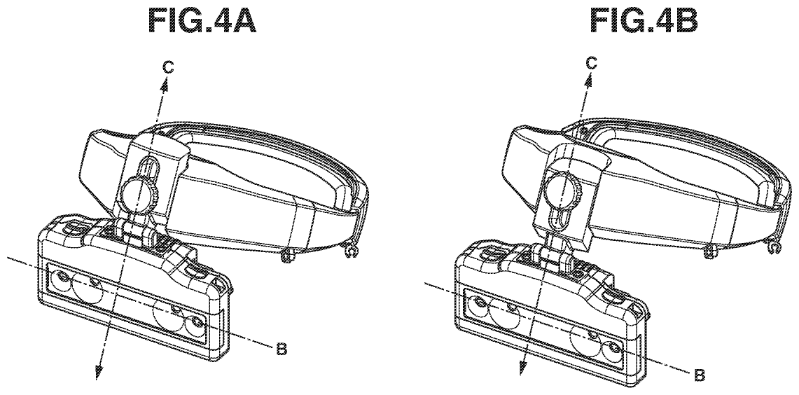

The above-described configuration enables the user to vertically adjust the position of the display unit 110 in one hand. FIG. 4A illustrates a state where the position of the display unit 110 according to the first exemplary embodiment is adjusted upward, and FIG. 4B illustrates a state where the position of the display unit 110 according to the first exemplary embodiment is adjusted downward. A straight line B is substantially parallel to a straight line connecting both eyes of the user, and a straight line C extends in a direction substantially orthogonal to the straight line B. As illustrated in FIGS. 4A and 4B, the display unit 110 can linearly move along the straight line C. Therefore, the display unit 110 can move in the vertical direction to the eyes of the user.

Subsequently, an HMD 200 according to a second exemplary embodiment is described. Components similar to those of the first exemplary embodiment are denoted by the same reference numerals as in the first exemplary embodiment, and descriptions of the components are omitted.

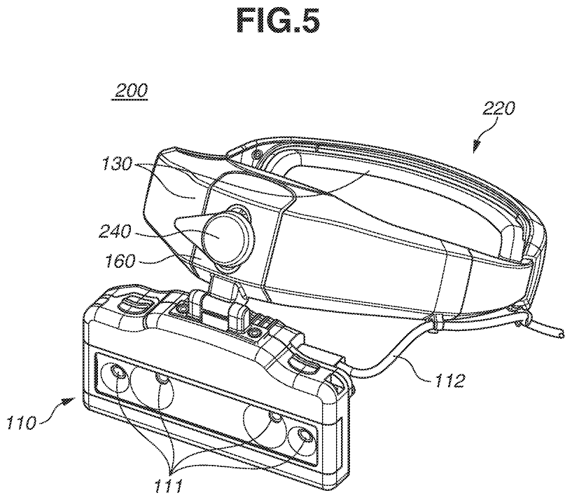

FIG. 5 is a bird's eye view of the HMD 200 according to the second exemplary embodiment. The HMD 200 includes the display unit 110, a mount portion 220, and the movable portion 160.

The mount portion 220 includes the fixing portion 130, an operation portion 240, and the rotor 150 (not illustrated). The operation portion 240 and the rotor 150 (not illustrated) are coupled in a rotation direction by the shaft 151 (not illustrated). The operation portion 240 has a lever shape, and the lever moves in the vertical direction. In this operation, force in the vertical direction acting on the fixing portion 130 is not balanced before the rotor 150 rotates; however, the operation force before the rotor 150 starts to rotate can be reduced because the operation portion 240 has the lever shape. As a result, the shift of the fixing portion 130 caused by operation of the operation portion 240 hardly occurs.

Further, when the position of the A portion where the rotor 150 (not illustrated) and the movable portion 160 engage with each other described in the first exemplary embodiment is appropriately set, the operation direction of the operation portion 240 and the movable direction of the movable portion 160 can be made substantially coincident with each other.

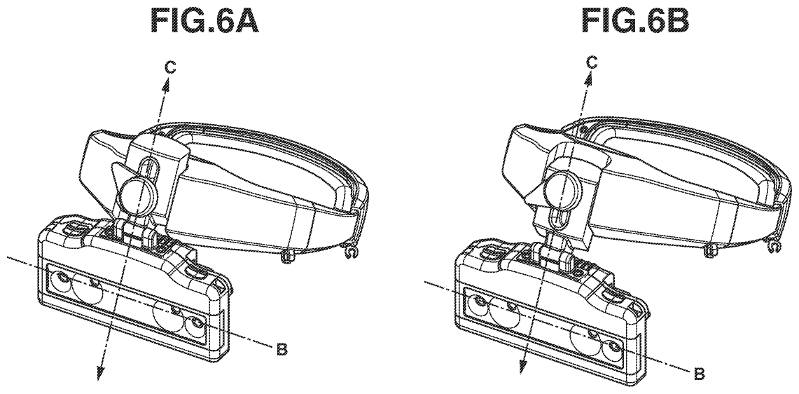

The above-described configuration enables the user to vertically adjust the position of the display unit 110 intuitively in one hand. FIG. 6A illustrates a state where the position of the display unit 110 according to the second exemplary embodiment is adjusted upward, and FIG. 6B illustrates a state where the position of the display unit 110 according to the second exemplary embodiment is adjusted downward.

According to the second exemplary embodiment, the operation direction of the operation portion and the movable direction of the movable portion are substantially coincident with each other in addition to the configuration of the first exemplary embodiment. This enables the user to vertically adjust the position of the display unit intuitively.

Subsequently, an HMD 300 according to a third exemplary embodiment is described. Components similar to those of the first exemplary embodiment are denoted by the same reference numerals as in the first exemplary embodiment, and descriptions of the components are omitted.

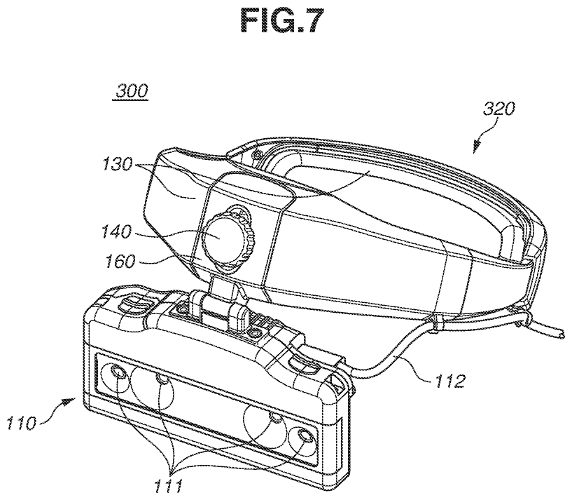

FIG. 7 is a bird's eye view of the HMD 300 according to the third exemplary embodiment. The HMD 300 includes the display unit 110, a mount portion 320, and the movable portion 160. The mount portion 320 includes the fixing portion 130, the operation portion 140, and a rotor 352 (not illustrated).

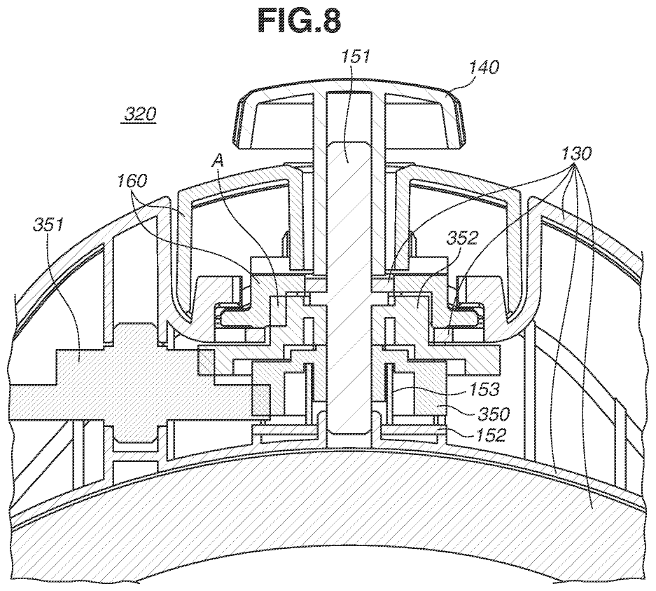

FIG. 8 is an internal cross-sectional view of the mount portion 320 according to the third exemplary embodiment. The mount portion 320 includes rotors 350, 351, and 352, the shaft 151, the friction plate 152, and the spring 153. The rotor 352 rotates with linear movement of the movable portion 160. The rotor 352 and the movable portion 160 may include, for example, a rack and a pinion, and are not limited to a specific configuration. The rotor 352 and the movable portion 160 engage with each other at the A portion. The operation portion 140 and the rotor 350 are coupled by the shaft 151. The rotor 351 engages with the rotor 350 and the rotor 352. The rotor 350 and the rotor 351 may include, for example, a pinion and a step gear, and are not limited to a specific configuration. Accordingly, when the rotation portion 140 rotates, the rotor 350 rotates and is decelerated, and the rotor 352 rotates. Since the rotor 352 and the movable portion 160 engage with each other at the A portion, rotary motion of the operation portion 140 is decelerated and converted into linear motion of the movable portion 160.

In the third exemplary embodiment, a deceleration mechanism is provided and the holding member causes friction to act on an acceleration side. Therefore, the linear movement of the movable portion 160 by the weight of the display unit 110 can be prevented by the friction force weaker than the friction force in the first exemplary embodiment.

The above-described configuration enables the user to vertically adjust the position of the display unit 110 with light force in one hand.

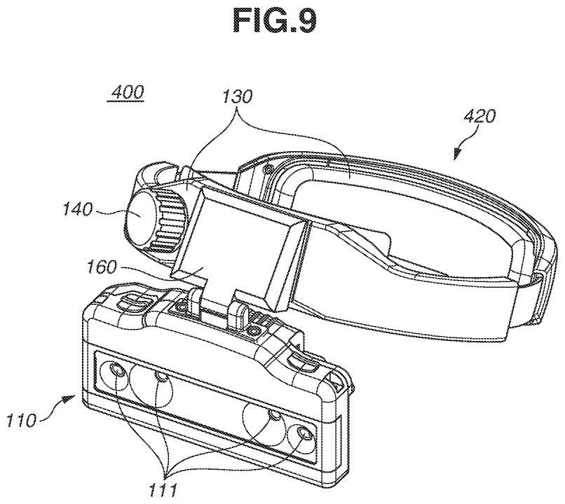

FIG. 9 is a bird's eye view of an HMD 400 in another mode according to the third exemplary embodiment. The HMD 400 includes the display unit 110, a mount portion 420, and the movable portion 160. The cable 112 is not illustrated.

The mount portion 420 includes the fixing portion 130, the operation portion 140, and a rotor 450 (not illustrated).

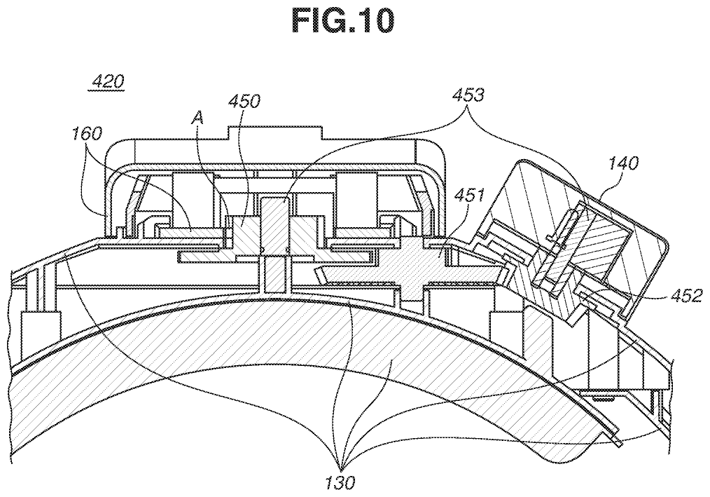

FIG. 10 is an internal cross-sectional view of the mount portion 420 in the other mode according to the third exemplary embodiment. The mount portion 420 includes rotors 450, 451, and 452, and a torque hinge 453.

The rotor 450 rotates with linear movement of the movable portion 160. The rotor 450 and the movable portion 160 may include, for example, a rack and a pinion, and are not limited to a specific configuration. The rotor 450 and the movable portion 160 engage with each other at the A portion. The operation portion 140 and the rotor 452 are coupled by the torque hinge 453. The rotor 451 engages with the rotors 452 and 450. The rotor 451 and the rotor 152 may include, for example, a step bevel gear and a bevel gear, and are not limited to a specific configuration. Accordingly, when the rotation portion 140 rotates, the rotor 452 rotates and is decelerated, and the rotor 450 rotates. Since the rotor 450 and the movable portion 160 engage with each other at the A portion, rotary motion of the operation portion 140 is decelerated and converted into linear motion of the movable portion 160.

The operation portion 140 and the rotor 452 are not necessarily coupled through the torque hinge 453; however, using the torque hinge 453 makes it possible to prevent damage of the components even if excessive operation torque acts.

The mount portion 420 includes a holding member to prevent the linear movement of the movable portion 160 by the weight of the display unit 110. The other end of the torque hinge 453 connected to the rotor 450 is connected to the fixing portion 130. This makes it possible to prevent the linear movement of the movable portion 160. The holding member may have a configuration using a spring as long as the holding member is a mechanism using friction.

In the other mode according to the third exemplary embodiment, the deceleration is performed by using the bevel gear. Therefore, it is possible to incline a rotation axis of the operation portion 140 along an outer shape of the fixing portion 130. As a result, it is possible to achieve downsizing and weight reduction of the HMD 400.

In the first exemplary embodiment, since the operation portion 140 is positioned at a center, the operation portion 140 is easily accessed by both of right and left hands. In contrast, in the third exemplary embodiment, the operation portion 140 is positioned at a position where the user naturally raises the right hand even though the operation portion 140 is accessed only by the right hand. This makes it possible to reduce burden of the user to look for the operation portion 140.

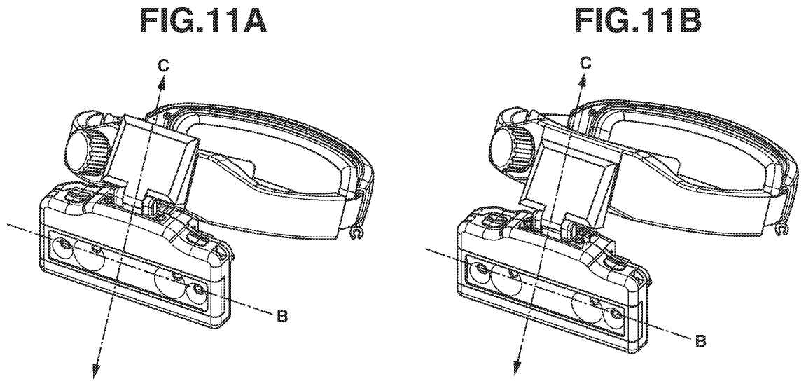

The above-described configuration enables the user to vertically adjust the position of the display unit 110 with light force in one hand. In addition, it is possible to enhance a degree of layout freedom of the operation portion 140. FIG. 11A illustrates a state where the position of the display unit 110 in the other mode according to the third exemplary embodiment is adjusted upward, and FIG. 11B illustrates a state where the position of the display unit 110 in the other mode according to the third exemplary embodiment is adjusted downward. According to the third exemplary embodiment, the operation force is decelerated in addition to the configuration of the first exemplary embodiment. This enables the user to vertically adjust the position of the display unit with lighter operation force. In addition, it is possible to enhance the degree of layout freedom of the operation portion.

Subsequently, an HMD 500 according to a fourth exemplary embodiment is described. Components similar to those of the first exemplary embodiment are denoted by the same reference numerals as in the first exemplary embodiment, and descriptions of the components are omitted.

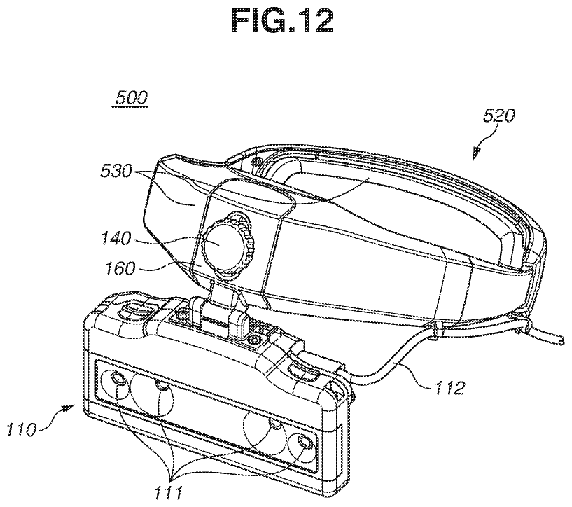

FIG. 12 is a bird's eye view of the HMD 500 according to the fourth exemplary embodiment. The HMD 500 includes the display unit 110, a mount portion 520, and the movable portion 160.

The mount portion 520 includes a fixing portion 530, the operation portion 140, and the rotor 150 (not illustrated). It is sufficient for the fixing portion 530 to fix the HMD 500 to the head of the user while being in contact with at least the front and back of the head of the user. The fixing portion 530 is not limited to a specific configuration and may include a plurality of components.

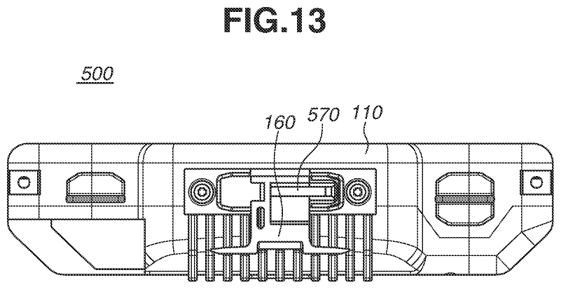

FIG. 13 is a cross-sectional view of a connection portion between the display unit 110 and the movable portion 160 of the HMD 500 according to the fourth exemplary embodiment. The movable portion 160 and the display unit 110 are connected by a rotary holding portion 570. As the rotary holding portion 570, for example, a torque hinge is adoptable; however, the rotary holding portion 570 is not limited thereto.

The user can directly hold the display unit 110 in one hand, and can tilt the display unit 110 forward/backward, Further, enlarging a front-back tilt angle makes it possible to withdraw (flip up) the HMD from the eyes of the user. Although the operation force is transmitted to the fixing portion 530, the force acts in a direction substantially perpendicular to the head pressing force. Therefore, the operation force hardly causes shift of the fixing portion 530.

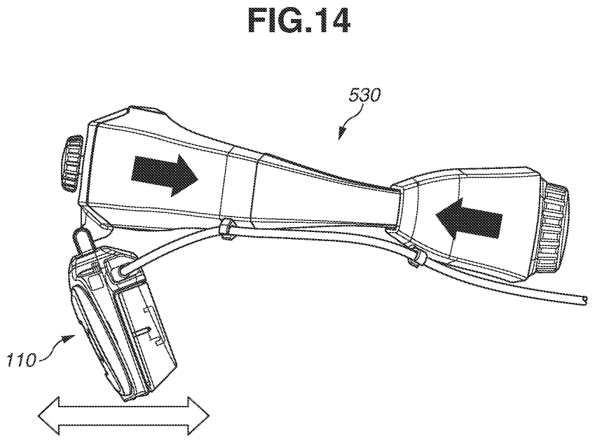

FIG. 11 illustrates a direction of the operation force to tilt the display unit 110 forward/backward, and a direction of the head pressing force by the fixing portion 530. As illustrated in FIG. 14, the operation force acts not in a shear direction but in a substantially perpendicular direction to the head pressing force. Therefore, the operation force hardly causes shift of the fixing portion 530.

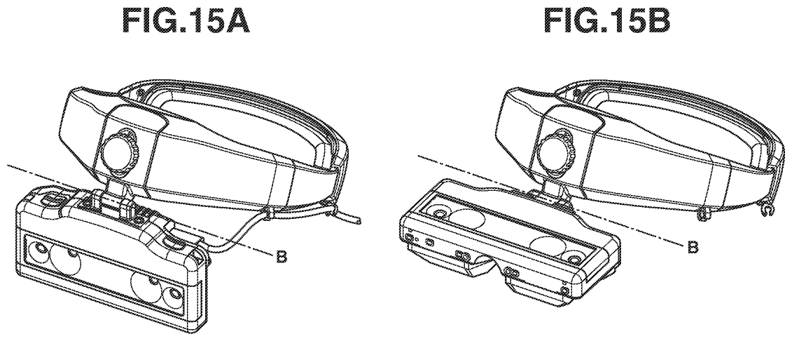

The above-described configuration enables the user to adjust the position of the display unit 110 upward/downward and forward/backward in one hand. FIG. 15A illustrates a state where the display unit 110 according to the fourth exemplary embodiment is positioned at a default position, and FIG. 15B illustrates a state where the display unit 110 according to the fourth exemplary embodiment is tilted and flipped up. The display unit 110 is tilted around the straight line B. According to the fourth exemplary embodiment, since the rotary holding portion to tilt the display unit forward/backward is provided in addition to the configuration of the first exemplary embodiment, it is possible to adjust the position of the display unit forward/backward. In addition, it is possible to flip up to withdraw the HMD from the eyes.

Although the exemplary embodiments of the present disclosure have been described above, the present disclosure understandably includes any combination of these exemplary embodiments, and these exemplary embodiments can be variously modified and alternated within the scope of the present disclosure.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2020-015877, filed Jan. 31, 2020, which is hereby incorporated by reference herein in its entirety.

What is claimed is:

1. A head mounted device to be mounted on a head of a user, the head mounted device comprising:
a display unit configured to display an image;
a movable portion configured to be movable with the display unit in a vertical direction to eyes of the user when the head mounted device is mounted on the head of the user;
an operation portion configured to be operable by the user; and
a rotor configured to rotate by operation of the operation portion and to move the movable portion by the rotation.

2. The head mounted device according to claim 1, further comprising a holding member configured to prevent the movable portion from moving by a weight of the display unit.

3. The head mounted device according to claim 2, wherein the holding member prevents the movable portion from moving, by using friction force.

4. The head mounted device according to claim 1, wherein the operation portion and the rotor are coupled to a deceleration mechanism.

5. The head mounted device according to claim 1,
wherein a holding member prevents the movable portion from moving, by using friction force,
wherein the operation portion and the rotor are coupled to a deceleration mechanism, and
wherein the friction force of the holding member acts on an acceleration side of the deceleration mechanism.

6. The head mounted device according to claim 1, wherein the display unit is tilted around a straight line substantially parallel to a straight line connecting both eyes of the user, relative to the movable portion.

7. The head mounted device according to claim 6, further comprising a rotary holding portion configured to hold a position of the tilted display unit.

8. The head mounted device according to claim 7, wherein the rotary holding portion is a torque hinge.

9. The head mounted device according to claim 1, wherein the operation portion is a dial that rotates to rotate the rotor.

10. The head mounted device according to claim 1, wherein the operation portion moves in a direction substantially coincident with a movable direction of the movable portion by the operation, and rotates the rotor by the movement.

11. The head mounted device according to claim 1, further comprising a camera configured to acquire a real image for generation of an image to be displayed on the display unit.
